(19) United States
(12) Patent Application Publication
(10) Pub. No.: US 2006/0062444 A1
(43) Pub. Date: Mar. 23, 2006

(54) Method for inspecting channel pipes

(76) Inventor: Heino Rehse, Raisdorf (DE)

Correspondence Address: LARSON AND LARSON, 11199 69TH STREET NORTH, LARGO, FL, 33773, US

(21) Appl. No.: 10/509,167

(22) PCT Filed: Jan. 24, 2003
(86) PCT No.: PCT/DE03/00195

§ 371 Date: Sep. 13, 2005

(30) Foreign Application Priority Data
Mar. 28, 2002 (DE) 102 13 931.8

(51) Int. Cl. G06K 9/00

(52) U.S. Cl. 382/141

(57) ABSTRACT

The invention relates to a method for inspecting channel pipes, wherein hemispherical or fully spherical digital images captured at various locations in the pipe by means of a camera provided with a fisheye lens are calculated and perspective images enabling a virtual swiveling are produced. The intermediate images arising for any specific neighboring location of the desired fictive camera position are calculated and represented on the basis of image data captured in a location wherein the geometry of the imaged pipe is known, by computationally projecting the captured images onto the known pipe geometry and calculating the perspective image data therefrom for the neighboring location.

### PRIOR APPLICATIONS

This §371 National Phase patent application bases priority on International Application No. PCT/DE03/00195, filed on Jan. 24, 2003, which in turn bases priority on German Application No. DE 102 13 931.8, filed on Mar. 28, 2002.

### BACKGROUND OF THE INVENTION

1. Field of the Invention

The invention relates to a method for inspecting pipes such as sewer pipes, pipelines, etc.

2. Description of the Prior Art

EP 1,022,553 b1 discloses a dolly displaceable within a channel pipe and which is set up for producing fully spherical images at defined path sections along the pipe axis (e.g. every 5 cm) using wide-angle lenses, particularly fisheye lenses. The digital image signals are stored and can be optically evaluated at a later time. U.S. Pat. No. 5,185,667 discloses a method for producing perspective images with swiveling, tilting, rotating and magnification functions from digital images produced with a fisheye lens, and permitting an observation of the images taken at the shooting point in different directions, but only as from said point.

Using this method for reproducing exposures of individual images at different locations in the channel pipe, by a suitable calculation of the image signals obtained, it is possible to consider any pipe all location, but only from the discreet locations where the exposures were made. On performing the dolly travel through the channel pipe or sewer, the image jumps from exposure location to exposure location. However, it is desirable during the subsequent virtual passage through the sewer to give the impression of an actual passage, i.e., to reproduce images from locations where, in fact, no exposure was made.

On the basis of discreet, hemispherical or fully spherical images recorded at clearly defined path sections of the pipe, the problem of the invention is to simulate a continuous, axial sewer inspection journey, i.e., producing perspective images at random locations outside the optical centres of the exposures taken.

### SUMMARY OF THE INVENTION

According to the invention, this problem is solved by the features of the main claim, whilst the subclaims give advantageous developments of the invention.

The invention makes use of the fact that in the case of pipe systems having a geometry (dimensions and profile) and camera location within the pipe being approximately known, it is possible to calculate from discreet images at clearly defined path sections (e.g. every 5 cm) continuous views along the pipe axis, which are between the actual original exposures.

Starting from the location of the camera in the pipe, for this purpose image data of the hemispherical or fully spherical images (one or two fisheye exposures) are computationally projected onto the inner surface of the known pipe geometry, and use is mathematically made of an infinitely long, three-dimensional pipe model. For each image point of the 2D-fisheye image P(Xf, Yf) with known imaging function (e.g. F-theta lens) are calculated the angle of incidence (α,θ of the spherical coordinates) and from this a corresponding image point in 3D-space P′(Xr, Yr, Zr) on the pipe inner surface. Such a 3D-scene can be built up for each location of the original exposures within the computer memory. Using known 3D graphic visualization techniques, it is possible to produce a two-dimensional, perspective view. Besides swiveling, tilting, rotating and magnifying functions, this also permits a translation (i.e., the simulation of an axial movement through the pipe at locations other than those of the original exposures).

If the fictive camera is now in the vicinity of a nearest original exposure, a new 3D-scene is built up with said exposure. The range of validity of a scene consequently corresponds to the spacing of the discreet original exposure centres.

In order to reduce the data quantity to be calculated (number of image points), it is also possible in the actual scene to only calculate from the desired, fictive camera position and its viewing angle in space the image point located in the desired section (region of interest) of the image plane B of the fictive camera. With the aid of a projection centre, calculation firstly takes place from the image point coordinates of the image plane B the corresponding image point coordinates on the inner surface of the known pipe geometry and from this the corresponding image point coordinates in the fisheye exposure, and in this way is obtained the colour and brightness value of the image point on image plane B with P″(Xb, Yb)=P(Xf, Yf). The necessary mathematics are known to the expert (trigonometry and Geometry of space).

Thus, figuratively speaking, the invention is based on the idea of projecting images recorded by the fisheye lens and starting from the recording location, onto the inner surface of an imaginary pipe and observing same after conversion from a random, progressing location into central perspective images.

### BRIEF DESCRIPTION OF THE DRAWINGS

Further advantages and features of the present invention can be gathered from the following description of the preferred embodiment relative to the attached drawings, wherein:

FIG. 1 shows a diagrammatic representation of the calculation of the intermediate images;

FIG. 2 shows the image plane of the fictive camera;

FIG. 3 shows the fisheye image.

### DETAILED DESCRIPTION OF THE PREFERRED EMBODIMENT

The following data are placed or are to be placed beforehand in the computer (computer program):

The pipe profile and its dimensions (e.g. circular profile with DN, or eye profile with dimensions), position of the fisheyes and angles of the optical axes thereof in the pipe.

Focal length of the fisheye and its imaging function (F-theta distortion), position, focal length, swiveling, tilting and rotation angle of the fictive camera.

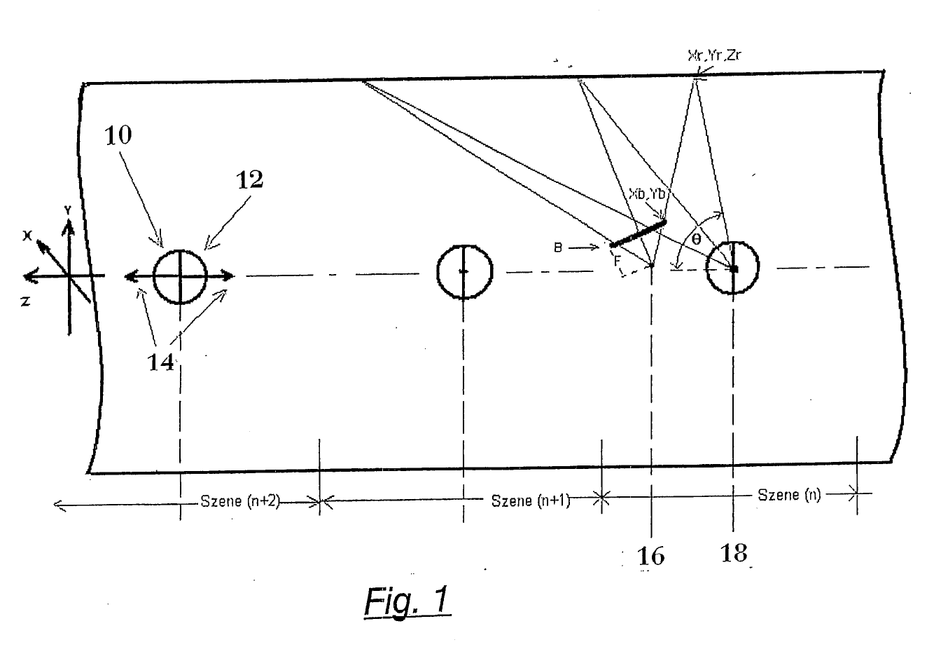

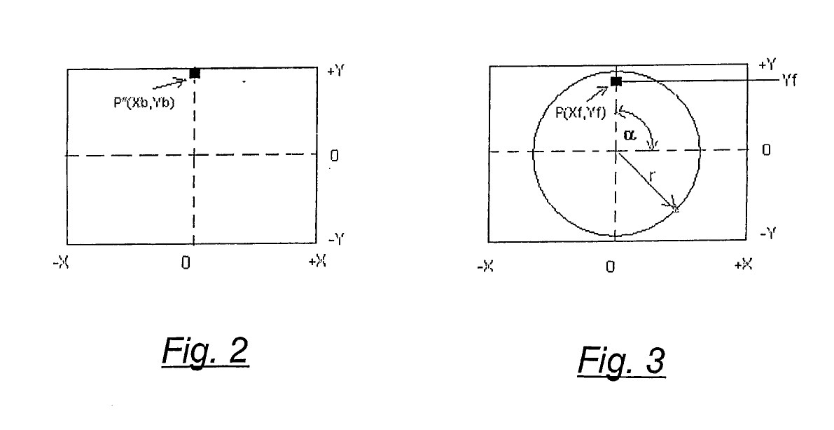

For simplification purposes, FIG. 1 only shows beams and coordinates on the Y-Z plane. The image plane B of the fictive camera is tilted upwards (not rotated and not swiveled). The optical axes 14 of the fisheye lenses 10, 12 correspond to the pipe axis.

B=fictive camera image plane;

F=fictive camera focal length (spacing of the image plane B or projection plane from the optical centre of the fictive camera or projection centre);

α, θ=angle of incidence in fisheye. θ being the angle to the Z-axis and α the angle formed by the beam projection on the X, Y plane with the X axis;

(Xb, Yb)=image point coordinates on the image plane B;

(Xr, Yr, Zr)=image point coordinates on the pipe wall;

P″(Xb, Yb)=P(Xf, Yf)

The image point coordinates (Xf, Yf) in the F-theta fisheye image are calculated from the angles of incidence θ and α with:
Yf=sin(α)*Ff*θ and Xf=cos(α)*Ff* θ,

in which Ff=focal length of fisheye lens.

In FIG. 1, the following applies:
α=Pi/2→Xf=O and Yf=θ.

In FIG. 1, it is assumed that at specific locations 18 within the pipe to be inspected, a fisheye lens 10 makes forwardly directed exposures and another fisheye lens 12 rearwardly directed exposures. From a fictive camera position 16 between the locations 18 where the original exposures were made, are acquired scenes built up as from the locations where the original exposures were made.

Having thus described the invention, what is claimed and desired to be secured by Letters Patent is:

1-3. (canceled)

4. A method for inspecting channel pipes, wherein hermispherical or fully spherical digital images recorded at specific locations in the pipe are calculated and perspective images enabling virtual swiveling are produced, the method comprising:
taking a known geometry of an imaged pipe from an image data at one location;
calculating and representing an intermediate image for a random neighboring location of a desired fictive camera position;
projecting a recorded image computationally onto the known pipe geometry; and
calculating a perspective image data resulting therefrom for a neighboring location.

5. The method according to claim 4, wherein calculating at each image point of a 2D-fisheye image P′(Xf, Yf) with known imaging function, the angle of incidence (α, θ) of the spherical coordinates, and from the calculation a corresponding image point in 3D space P(Xr, Yr, Zr) on the pipe surface is represented.

6. The method according to claim 4, wherein calculating from the desired fictive camera position and its viewing angle in space, an image point located in a desired section of an image plane, and taking from image point coordinates (Xb, Yb) of the image plane and assuming a projection center at a distance F from the image plane B, calculating corresponding image point coordinates (Xr, Yr, Zr) on the inner surface of the known pipe geometry and corresponding image point coordinates (Xf, Yf) of a fisheye image, so that the color and brightness value of an image point on image plane B with P″(Xb, Yb)=P(Xf, Yf) is obtained.
